(19) United States
(12) Patent Application Publication
(10) Pub. No.: US 2015/0023717 A1
(43) Pub. Date: Jan. 22, 2015

(54) Liquid Condiment Applicator

(71) Applicant: Larry Warren Lewis, Chesterfield, VA (US)

(72) Inventor: Larry Warren Lewis, Chesterfield, VA (US)

(21) Appl. No.: 14/330,594

(22) Filed: Jul. 14, 2014

Related U.S. Application Data
(60) Provisional application No. 61/847,849, filed on Jul. 18, 2013.

(51) Int. Cl. B05C 17/005; A47J 9/00; A46B 11/06

(52) U.S. Cl. CPC B05C 17/00506; A46B 11/063; B05C 17/00569; A47J 9/001
USPC 401/188 R

(57) ABSTRACT

A liquid condiment applicator device is provided. The present invention comprises a liquid-containing bottle with a threaded opening, a bottle head having a complementary threaded connector and an internal pump assembly, a rigid elongated tube extending from the head, and at least two different removable attachments that are affixable to a free end of the elongated tube. The removable attachments further include a brush adapted to allow liquid to flow therethrough and an injector needle adapted to allow individuals to inject liquid into food for marinating and other such purposes. The internal pump assembly functions similarly to a conventional spray bottle, i.e. the user can squeeze a trigger to draw liquid through an internal tube and disperse the liquid through the rigid elongated tube. The rigid elongated tube allows individuals to baste food cooking over an open flame without the user having to reach as far over the flame.

### CROSS REFERENCE TO RELATED APPLICATION

This application claims the benefit of U.S. Provisional Application No. 61/847,849 filed on Jul. 18, 2013, entitled “BBQ Brush.” The above identified patent application is herein incorporated by reference in its entirety to provide continuity of disclosure.

### BACKGROUND OF THE INVENTION

1. Field of the Invention

The present invention relates to barbeque or grill basting devices. More specifically, the present invention relates to barbeque or grill basting devices that are adapted to dispense liquid, such as barbecue sauce or a marinade, held within a container through a brush or other such applicator, allowing the user to keep his or her hands further away from the heat or flames generated by the grill or barbecue. The present invention can also be used to distribute a variety of condiments, such as ketchup or mustard, quickly and efficiently when making large quantities of burgers, sandwiches, hot dogs, and the like.

Grilling and barbecuing are activities that are well-loved by many individuals and various types of equipment have been created for individuals who enjoy engaging in these pursuits. This huge variety in available equipment has a created a glut and is not manageable for many individuals because every piece of equipment has a hyper-specialized purpose. Therefore, there is a need in the prior art for a grilling or barbecuing device that combines various aspects of multiple different pieces of cooking equipment and that is convenient and easy to use.

Spray bottles are often used by barbecuing and grilling enthusiasts to baste food that is being cooked because the spray bottles can apply liquid to food at a distance, without requiring that the user reach his or her hand over an open flame or into a smoker. However, the spray patterns on these spray bottles often result in a substantial amount of waste because it is difficult for users to ensure that all of the liquid reaches the food without positioning the spray bottle very close to the food, which negates the entire purpose of using a spray bottle in the first place. Furthermore, injector needles for injecting marinade into food are also known in the prior art, but these injector needles are only useful for that single purpose and have little to no additional utility.

The present invention provides a liquid applicator device that has removable brush and injector needle portions so that it may be used for a variety of purposes. The present invention comprises a bottle having a head portion with an internal pump mechanism actuated by a trigger and a body portion to hold liquid, such as barbecue sauce, marinade, or condiments. A rigid elongated tube extends from the head portion. A plurality of removable applicators are affixable to the free end of the elongated tube. The internal pump mechanism is the same type of pump mechanism as is commonly known in the prior art of spray bottles. The pump mechanism draws liquid from the bottle body, through the open end of the internal tube, and drives said liquid through the elongated tube and expels the liquid from the applicator. The brush applicator has a plurality of bristles, allowing the present invention to serve as a mop with which food may be basted. The injector needle applicator has a needle with a pointed end to pierce the exterior of a food product, thereby allowing marinade to be injected into the food to improve the consistency and quality of the marinating process.

2. Description of the Prior Art

Devices have been disclosed in the prior art that relate to liquid dispensing devices. These include devices that have been patented and published in patent application publications. These devices generally relate to liquid containers that are adapted to dispense liquid either through a brush or a spray nozzle. The following is a list of devices deemed most relevant to the present disclosure, which are herein described for the purposes of highlighting and differentiating the unique aspects of the present invention, and further highlighting the drawbacks existing in the prior art.

One such device is U.S. Pat. No. 4,796,806 to Reid, which discloses a barbecue sauce sprayer comprising a container, a pump for pumping the sauce out of the container, and a nozzle having a plurality of holes to disperse the barbecue sauce in a spray pattern. The Reid device represents a conventional spray bottle that may be used to baste food cooking on a grill or in a smoker. Such spray bottles are adapted to apply barbecue sauce and other such liquids at a distance, obviating the need for the user to directly baste food with a mop. However, such spray bottles waste a substantial amount of the barbecue sauce because the spray pattern is generally wide and thus the liquid is sprayed over a larger area than the food occupies when the user is standing at a distance. Spray bottles can also cause dangerous flare-ups when flammable sauces miss the targeted food items and land in open flames. Furthermore, unburnt sauce that was haphazardly sprayed onto the grill and missed the food items has a tendency to clog up burner holes and cause premature rusting of gas grills. The present invention, on the other hand, comprises a removable brush applicator that can be used at a distance because it is affixed at the end of an elongated, rigid tube. The brush applicator lets users baste food at a distance, but does so in a tight and controlled manner that does not result in any waste because it directly applies the liquid to the food being cooked, rather than ejecting it via a spray nozzle or head.

Liquid brush applicator heads are also known in the prior art. U.S. Pat. Nos. 5,547,303, 5,716,104, 6,109,810, 8,240,938, 8,262,307 and U.S. Published Patent Application Publication No. 2010/0290828 all disclose such devices. The present invention also comprises a brush head through which liquid may be dispensed, however, the present invention further comprises an elongated tube and an additional injector needle applicator that provides the present invention with further functionality not found in any of these prior art devices.

A barbecue liquid applicator is provided. The present invention is adapted for both basting food being cooked over a grill or in a smoker and marinating food prior to it being cooked. The present invention comprises a bottle having an interior volume for holding liquid, a removably connected head portion having an internal pump mechanism and an internal tube extending into the bottle's interior volume, a rigid elongated tube extending from said head portion, and a plurality of removable applicators. The removable applicators comprise a brush applicator, which is adapted for basting food with sauce and other condiments, and an injector needle applicator, which is adapted for injecting marinade directly into a piece of food to increase the speed and effectiveness of the marinating process. The present invention substantially diverges in design elements from the prior art and consequently it is clear that there is a need in the art for an improvement to existing liquid applicator devices. In this regard the instant invention substantially fulfills these needs.

### SUMMARY OF THE INVENTION

In view of the foregoing disadvantages inherent in the known types of liquid applicator devices, such as spray bottles and mops, now present in the prior art, the present invention provides a new barbecue and other liquid condiment applicator wherein the same can be utilized for providing convenience for the user when both marinating meat before cooking and when actively cooking food, or in the preparation of large quantities of burgers, sandwiches, hot dogs, or other such food items.

It is therefore an object of the present invention to provide a new and improved liquid applicator device that has all of the advantages of the prior art and none of the disadvantages.

It is another object of the present invention to provide a liquid applicator device that is adapted for use in both marinating, basting food, preparing burgers, sandwiches, hot dogs, and other such food items.

Another object of the present invention is to provide a liquid applicator device that is adapted to allow a user to baste food that is being cooked over an open flame without the user having to reach as far over the open flame.

Another object of the present invention is to provide a liquid applicator device that has a plurality of removable attachments, including a brush attachment and an injector needle attachment.

Yet another object of the present invention is to provide a liquid applicator device that reduces the waste of condiments.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a side view of the present invention.

FIG. 2 shows an exploded view of the present invention, with a callout showing the elongated tube disconnected from the head portion of the present invention.

### DETAILED DESCRIPTION OF THE INVENTION

Reference is made herein to the attached drawings. Like reference numerals are used throughout the drawings to depict like or similar elements of the liquid condiment applicator. For the purposes of presenting a brief and clear description of the present invention, the preferred embodiment will be discussed as used for marinating meat and basting food being cooked over an open flame or preparing sandwiches and buns. The figures are intended for representative purposes only and should not be considered to be limiting in any respect.

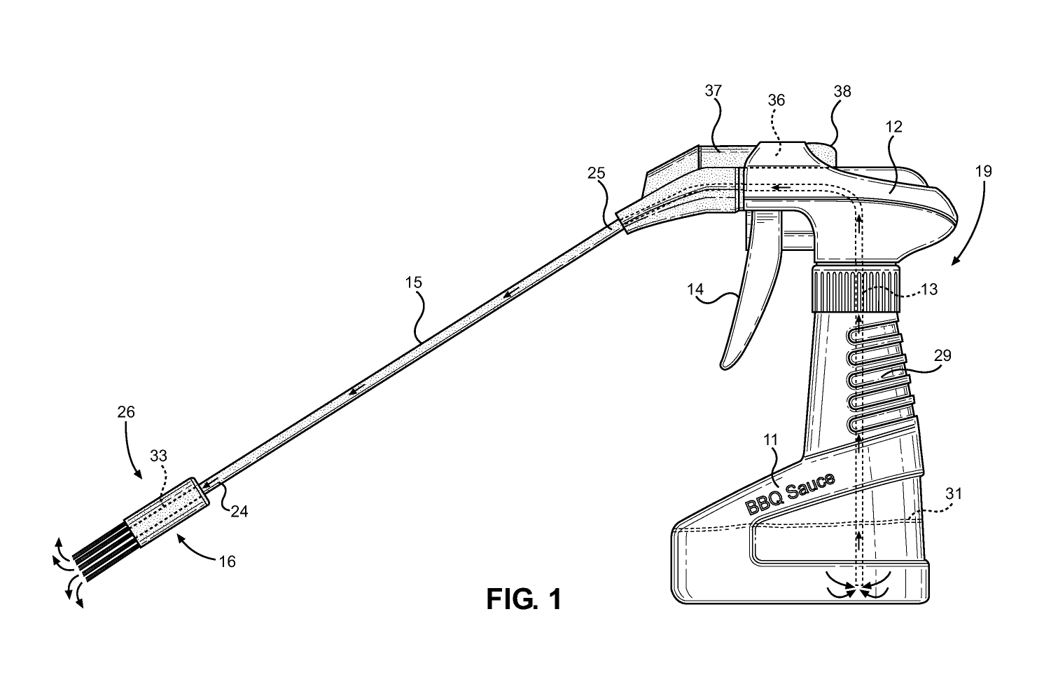

Referring now to FIG. 1, there is shown a perspective view of the present invention. The present invention comprises a bottle 19, an elongated tube 15 extending from the bottle 19, and at least one applicator 26, which is a brush 16 in the depicted embodiment, which is removably affixed to a free end of the elongated tube 15. The elongated tube 15 is rigid and thereby lets users apply liquids, such as barbecue sauce, to foods that are cooking over an open flame, without having to actually reach as far over the open flame and risk being burned by the fire. The elongated tube 15 is either composed of plastic with a fire-retardant coating or is composed of a fire-resistant plastic material. It is submitted that such coatings and heat-resistant plastic materials are well-known in the prior art. The elongated tube 15 may be disposed at any angle relative to the vertical axis of the bottle 19, i.e. in some embodiments the elongated tube 15 extends at an acute angle from the bottle 19, in some embodiments it extends at a perpendicular angle, and in some embodiments it is disposed at an obtuse angle therefrom.

The elongated tube 15 has a first end 24 and a second end 25. The second end 25 is affixed to the head portion 12 of the bottle 19 by any means commonly known in the prior art. The second end 25 has a head connector portion 37 extending therefrom that removably engages with the bottle head 12. In one embodiment of the present invention, the elongated tube 15 is removably connected to the head connector portion 37. In another embodiment of the present invention, the elongated tube 15 is integrally connected to the head connector portion 37. In the depicted embodiment, the head connector portion 37 comprises a connecting member 38 that extends through a complementary channel 36 disposed on the bottle head 12. The connecting member 38 is affixed to the bottle head 12 via fitment between the connecting member 38 and the channel 36, via depressible spring tabs that lock into complementary recesses when the connecting member 38 is inserted through the channel 36, via a threaded connection between the connecting member 38 and the bottle head 12, or any other such means for removably connecting the components together. The depicted embodiment is merely intended to be exemplary and should not be construed so as to be limiting in any way. The first end 24 of the elongated tube 15 has a connector adapted to secure a plurality of removable applicators 26 thereon. In the preferred embodiment, the connector comprises a threaded or snap-in portion disposed at the first end 24 of the elongated tube 15 that is adapted to engage with a complementary threaded or snap-in portion on the applicator 26. However, the present disclosure contemplates any other type of removable or temporary connection commonly known in the prior art, including hook-and-loop fastener material, a tab system comprising a plurality of flanges that are adapted to engage with complementary apertures or channels, or fitment between the applicators 26 and the first end 24 of the elongated tube 15.

The bottle 19 comprises a head portion 12 that is removably affixed to an opening of a bottle body 11. The bottle body 11 comprises at least one sidewall extending about the perimeter of a base, creating an internal volume adapted to contain liquid 31, such as barbecue sauce or other condiments. The bottle body 11 preferably comprises an elongated neck portion and a textured grip surface 29 that is designed such a user may conveniently hold the present invention when in use. However, no claim is made as to the precise size, shape, or design of the bottle body 11 or the head portion 12. The bottle 19 is preferably composed of a durable plastic material, however no claim is made as to the specific material.

The head portion 12 of the bottle 19 comprises an internal pump assembly (not shown) as is commonly known in the prior art of spray bottles. The internal pump assembly is actuated by a trigger 14 disposed on the front portion of the head portion 12. When the trigger 14 is actuated by the user, it causes the internal pump system to draw liquid 31 through the internal tube 13 and then drives the liquid through the head portion 12 and then the elongated tube 15, before expelling the liquid 31 out of the removable applicator 26 connected to the free first end 24 of the elongated tube 15. As described above, the second end 25 of the elongated tube 15 may be either integrally connected to the head portion 12 or may be removably connected thereto via any means commonly known in the prior art, including via a threaded connection or fitment between the two components. As with the bottle body 11, no claim is made as to the precise size, shape, or design of the head portion 12.

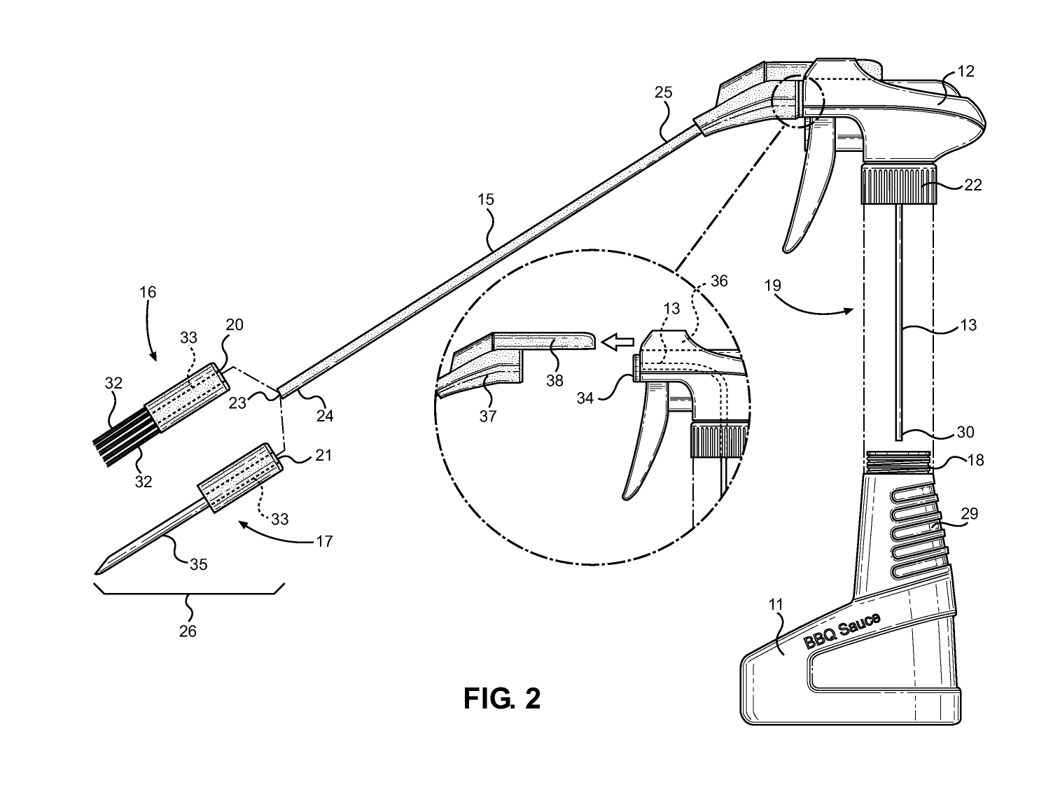

Referring now to FIG. 2, there is shown an exploded view of the present invention. In the depicted embodiment of the present invention, the applicators 26, elongated tube 15, head portion 12, and bottle body 11 are all removably connected together so that the present invention can be disassembled for convenient cleaning. The present invention further comprises a threaded cap 34 that is removably affixable over the open end of the internal tube 13 that is exposed when the elongated tube 15 and the connector portion 37 are removed from the bottle head 12. The cap 34 allows for convenient storage of condiments, marinades, and other liquids stored within the bottle 19 when the elongated tube 15 is removed therefrom. All of the various components are all preferably composed of a heat-resistant, durable plastic material so that the present invention can be used around grills and other open heat sources without concern that the various components will melt. The head portion 12 has a threaded connector 22 that engages with a complementary threaded opening 18 disposed on the top portion of the bottle body 11. The internal tube 13 extends from the head portion 12, through the threaded connector 22 and is held in a fixed position within the internal volume of the bottle body 11. The positioning of the internal tube 13 allows the internal pump assembly to draw liquid from the internal volume of the bottle 19, through the internal tube open end 30.

A plurality of applicators 26 may be provided with the present invention, including a brush 16 and an injector needle 17. The applicators 26 have the same general function in that they allow liquid to be ejected therethrough, but they each provide the present invention with unique additional functionality. Each of the applicators 26 has a connector 20, 21 that engages with a complementary connector portion 23 on the first end 24 of the elongated tube 15. In one embodiment of the present invention, the applicators 26 comprise internal threading, which engages with a complementary threaded tube connector 23. However, no claim is made as to the precise means of removable connection between the elongated tube 15 and the applicators 26.

One of the applicators 26 comprises a brush 16. The brush applicator 16 comprises a body portion with a channel 33 therethrough and a plurality of bristles 32 arranged around the open end of the channel 33. The bristles 32 may be either hard or soft, such as with a mop, and are composed of any material commonly known in the prior art. The channel 33 is arranged such that it is aligned with the open end of the elongated tube 15. This allows liquid driven through the elongated tube 15 by the internal pump assembly to be ejected therefrom through the brush applicator 16. As liquid, such as barbecue sauce, is ejected from the open end of the channel 33, it collects in the bristles 32, allowing the user to baste food.

The second depicted applicator 26 comprises an injector needle 17. The injector needle applicator 17, as with the brush applicator 16, comprises a body portion with a channel 33 therethrough. The injector needle applicator 17 further comprises a hollow needle 35, which is aligned with the channel 33 and thereby allows the user to pierce the exterior of a piece of food and drive liquid into the food's interior for marinating and other such purposes. The needle 35 comprises an inner channel that is aligned with the channel 33 disposed through the body portion of the injector needle applicator 17 and a sharp, pointed open end. No claim is made as to the size or gauge of the needle 35.

In use, the user may remove the head portion 12 of the bottle 19 and place a variety of liquids within the bottle body 11, such as barbecue sauce or marinades. The head portion 12 may then be affixed in place onto the threaded opening 18 of the bottle 19, which immerses the internal tube open end 30 within the liquid and allowing the liquid to be drawn therethrough to the other components of the present invention. The user may then choose the appropriate applicator 26 for his or her intended purpose. The injector needle applicator 17 is adapted to inject liquid into food to improve in marinating the food. The brush applicator 16 is adapted to basting food that is being cooked. The rigid elongated tube 15 is ideally suited for basting because its length lets a user apply barbecue sauce to food, without the user actually having to extend his or her hand as far over an open flame, when grilling, or into a smoker. This protects the user from burns or having to endure uncomfortable amounts of heat or smoke, without sacrificing any functionality.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A liquid applicator device comprising:
a bottle having an internal volume, a head portion, and an internal pump assembly;
an elongated tube having a first end and a second end;
said second end of said tube affixed to said bottle;
an applicator removably affixed to said elongated tube first end;
wherein said pump assembly is adapted to draw a liquid disposed within said internal volume of said bottle and disperse said liquid through said applicator.

2) The liquid applicator device of claim 1, wherein said applicator is a brush having a plurality of bristles and a channel adapted to allow liquid to flow therethrough.

3) The liquid applicator device of claim 1, wherein said applicator is an injector needle.

4) The liquid applicator device of claim 1, wherein said elongated tube is composed of heat-resistant material.

5) The liquid applicator device of claim 1, wherein said elongated tube is composed of rigid material.

6) A liquid applicator device comprising:
a hollow bottle body having a threaded opening;
a bottle head having an internal pump assembly, a threaded connector, an inner tube disposed through said threaded connector, and a trigger adapted to actuate said internal pump assembly;
an elongated tube having a first end and a second end;
said second end of said elongated tube affixed to said bottle head;
said first end of said elongated tube having a connector;
an applicator being removably affixed to said elongated tube first end by said connector;
wherein said pump assembly is adapted to draw a liquid held within said bottle body and disperse said liquid through said applicator.

7) The liquid applicator device of claim 5, wherein said applicator is a brush having a channel.

8) The liquid applicator device of claim 5, wherein said applicator is an injector needle.

9) The liquid applicator device of claim 5, wherein said elongated tube is composed of a heat-resistant material.

10) The liquid applicator device of claim 6, wherein said elongated tube is composed of rigid material.
